(19) United States
(12) Patent Application Publication
(10) Pub. No.: US 2008/0230318 A1
(43) Pub. Date: Sep. 25, 2008

(54) Lubricant dispenser

(76) Inventor: Egon Eisenbacher, Karlstadt (DE)

Correspondence Address: COLLARD & ROE, P.C., 1077 NORTHERN BOULEVARD, ROSLYN, NY, 11576, US

(21) Appl. No.: 11/980,992

(22) Filed: Oct. 31, 2007

(30) Foreign Application Priority Data
Nov. 15, 2006 (DE) 20 2006 017 522.9

(51) Int. Cl. F16N 11/08

(52) U.S. Cl. 184/37

(57) ABSTRACT

A lubricant dispenser has a lubricant container that has an outlet opening for lubricant, and has a piston disposed in the lubricant container. The piston can be moved towards the outlet opening for the purpose of dispensing lubricant. There is at least one prong that presses against the inside wall of the lubricant container, is made of a harder material than the lubricant container and is disposed on the piston circumference.

### BACKGROUND OF THE INVENTION

1. Field of the Invention

The invention relates to a lubricant dispenser having a lubricant container that has an outlet opening for lubricant, and a piston disposed in the lubricant container, which can be moved towards the outlet opening for the purpose of dispensing lubricant.

2. The Prior Art

A device having the characteristics listed above is described in German Patent No. DE 10 2005 004 456 A1. With lubricant dispensers of this type, they are generally filled many times by the users, contrary to the manufacturer's instructions. This generally leads to malfunction of the device, and the manufacturer is then exposed to warranty claims, many of which are unjustified.

A press-out device having a manual operation is described in German Patent No. DE 42 44 982 B4. This device contains a film bag with injection mass. The film bag is compressed by a piston, on which several combs are disposed. The combs interact with grooves on the inside wall of the press-out device, in order to prevent rotation of the piston during the press-out process.

### SUMMARY OF THE INVENTION

It is therefore an object of the invention to provide a lubricant dispenser, in which refilling of the container, which is undesirable because it is frequently carried out improperly, is prevented.

This object is accomplished according to the invention by a lubricant dispenser having at least one prong that presses against the inside wall of the lubricant container, is made of a harder material than the lubricant container, and is disposed on the piston circumference. According to the invention, this prong leads to the targeted formation of grooves on the inside wall of the lubricant container when lubricant is dispensed, and the piston moves towards the outlet opening as this happens. This damage occurs in an inside wall region of the lubricant container to which lubricant is no longer applied, i.e. the prong is outside of the region of the container that is to be sealed off by the piston and contains lubricant. Because of the targeted damage to the inside wall of the container, a reliable seal of the container by the piston is no longer possible when the container is refilled, so that lubricant can exit between the inside wall of the container and the outer circumference of the piston, and accordingly, the lubricant dispenser is no longer capable of functioning. In this way, use of the lubricant dispenser after refilling, which is undesirable because it is frequently performed improperly, is prevented, to a great extent. Furthermore, it becomes evident to the manufacturer in case of a complaint whether or not the lubricant dispenser being complained of was already refilled. In case of refilling, there are also grooves on the inside wall in the region of the container in which lubricant is present. These grooves were formed by the prong the first time the container was emptied.

Preferably, several prongs are provided on the piston circumference. For practical purposes, these can be provided in the form of prong profiles having several prongs each, which are uniformly distributed over the piston circumference. The prong can be disposed on a locking ring connected with the piston so as to prevent rotation, which preferably snaps into the piston during assembly. In this way, it is assured that the prong cannot be removed by the user.

In a preferred embodiment of the invention, the prong is inclined at a slant towards the inside wall of the lubricant container, and in this connection is directed away from the outlet opening. In this way, the piston cannot be moved away from the outlet opening for the purpose of refilling the container, since the prong blocks this movement by its orientation. At the very least, a plastic deformation of the lubricant container will take place if such an attempt is made, making the container unusable.

It is practical if the lubricant container consists of plastic, and the prong consists of sheet steel. Preferably, a prong is disposed on the upper edge of the piston. Accordingly, the groove formation occurs only in the region of the inside wall of the container in which a sealing effect is no longer required to be present.

The piston can have an elastomer sealing ring below the prong, on the circumference, which ring seals a gap between the inside wall of the lubricant container and the piston. It is practical if an inside thread for accommodating a spindle that moves the piston towards the outlet opening during dispensing of lubricant is provided in the center of the piston. In this case, the prong according to the invention fulfills an additional purpose, since the groove formation brings about an anti-twist lock, which absorbs the torque transferred to the piston by the spindle during the spindle movement. Accordingly, undesirable rotation of the piston during the spindle movement is reliably prevented by the groove formation. In the state of the art, this torque support takes place exclusively by way of the bias of elastomer sealing rings disposed on the piston. At higher temperatures, at which a lubricant container made of plastic expands relatively greatly, this frequently results in rotation of the piston, i.e. in leaks.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a side view of a lubricant dispenser according to one embodiment of the invention;

FIG. 2 shows a top view X of FIG. 1; and

FIG. 3 shows a three-dimensional representation of the lubricant dispenser according to FIG. 1.

### DETAILED DESCRIPTION OF THE PREFERRED EMBODIMENT

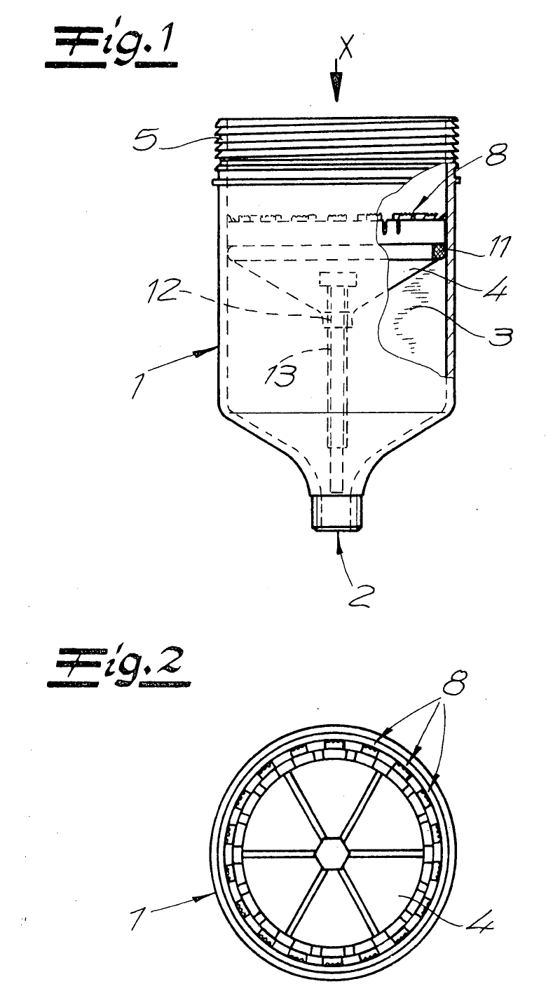

Referring now in detail to the drawings, FIG. 1 shows a lubricant dispenser having a lubricant container 1 that has an outlet opening 2 for lubricant 3, and a piston 4 disposed in lubricant container 1, which can be moved towards the outlet opening 2 for the purpose of dispensing lubricant. Piston 4 thus delimits the region of the lubricant container 1 that is filled with lubricant 3.

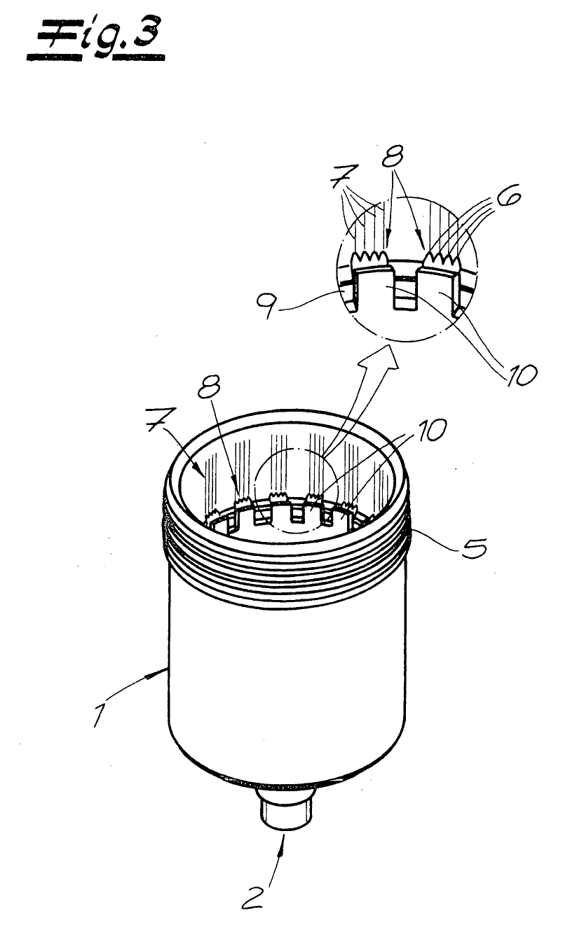

A thread 5 for closing off lubricant container 1 is provided at the upper edge of container 1. It can be seen in FIGS. 2 and 3, in particular, that several prongs 6 that press against the inside wall of lubricant container 1 are disposed on the piston circumference. These consist of a harder material as compared with lubricant container 1. When piston 4 moves towards outlet opening 2, prongs 6 lead to the formation of grooves 7 on the inside wall of the lubricant container 1. However, this occurs in a region that is no longer filled with lubricant 3, so that the groove formation does not impair the seal of the lubricant container 1 when it is emptied for the first time.

FIG. 2, in particular, shows that prongs 6 are disposed in the form of prong profiles 8 uniformly distributed over the piston circumference, which profiles each have several prongs 6. In this embodiment, there are four on each profile. The prong profiles 8 are disposed on a locking ring 9 connected with piston 4 so as not to rotate, which ring snaps into piston 4 during assembly and thus cannot be removed by the user. To secure prong profiles 8, piston 4 possesses several press-down elements 10, whereby one press-down element 10 is assigned to each prong profile 8. Prongs 6 are inclined towards the inside wall of lubricant container 1 at a slant, and, in this connection, directed away from outlet opening 2, in other words are directed towards closure thread 5 of container 1, accordingly. Lubricant container 1 consists of a comparatively soft plastic, while prongs 6 are made of sheet steel. Prongs 6 are disposed at the upper edge of piston 4. Piston 4 has an elastomer sealing ring 11 on the circumference, below prongs 6, which ring seals a gap between the inside wall of lubricant container 1 and piston 4. An inside thread 12 is provided in the center of the piston, to accommodate a spindle 13 that moves piston 4 towards outlet opening 2. Spindle 13 is generally driven by an electric motor, not shown in any detail.

In the exemplary embodiment, prong profiles 8 perform two functions. First, they make the lubricant dispenser unusable for refilling, by means of the groove formation on the inside wall of lubricant container 1, since the inside wall of lubricant container 1 that is provided with grooves 7 can generally no longer be sealed by elastomer sealing ring 11. Second, the slanted orientation of prongs 6 towards closure thread 5 makes a movement of piston 4 away from outlet opening 2 significantly more difficult; such a movement is required for refilling container 1. In the case of such a procedure, the container 1 is at least deformed in such a manner that it becomes unusable. However, the groove formation from prong profiles 8 also fulfills the purpose that the torque transferred to inside thread 12 of piston 4 by spindle 13 during a spindle movement is supported by way of grooves 7 on the inside wall of the lubricant container, and thus piston 4 is reliably prevented from rotating.

Accordingly, while only a few embodiments of the present invention have been shown and described, it is obvious that many changes and modifications may be made thereunto without departing from the spirit and scope of the invention.

What is claimed is:

1. A lubricant dispenser comprising:
a lubricant container that has an outlet opening for lubricant;
a piston disposed in the lubricant container, said piston being movable towards the outlet opening for dispensing lubricant; and
at least one prong disposed on a circumference of the piston, said at least one prong pressing against an inside wall of the lubricant container and said at least one prong being made of a harder material than a material of the lubricant container.

2. A lubricant dispenser according to claim 1, wherein there are several prongs disposed in prong profiles, each profile having several of said prongs, said prong profiles being uniformly distributed over the piston circumference.

3. A lubricant dispenser according to claim 1, wherein said at least one prong is disposed on a locking ring connected with the piston so as to prevent rotation.

4. A lubricant dispenser according to claim 1, wherein said at least one prong is inclined at a slant towards the inside wall of the lubricant container and is directed away from the outlet opening.

5. A lubricant dispenser according to claim 1, wherein the lubricant container consists of plastic, and the prong consists of sheet steel.

6. A lubricant dispenser according to claim 1, wherein the prong is disposed on the upper edge of the piston.

7. A lubricant dispenser according to claim 1, further comprising an elastomer sealing ring disposed below the prong, on the circumference of the piston, said ring sealing a gap between the inside wall of the lubricant container and the piston.

8. A lubricant dispenser according to claim 1, further comprising an inside thread that accommodates a spindle that moves the piston towards the outlet opening, said thread being disposed in a center of the piston.
